(19) United States
(12) Patent Application Publication
(10) Pub. No.: US 2005/0040253 A1
(43) Pub. Date: Feb. 24, 2005

(54) Pressurized accumulator tank for flowable materials

(76) Inventor: David L. Thornton, Troy, MI (US)

Correspondence Address: Stephen D. Harper, Henkel Corporation;Law Department, Suite 200, 2500 Renaissance Blvd., Gulph Mills, PA, 19406, US

(21) Appl. No.: 10/645,424

(22) Filed: Aug. 21, 2003

(51) Int. Cl. B05B 9/03; A62C 13/62; A62C 13/66

(52) U.S. Cl. 239/302; 239/398; 239/419.5

(57) ABSTRACT

A pressurized accumulator tank includes a perforated anti-collapse supply/discharge tube in a shell like vessel. An expandable flexible bladder is mounted around the supply/discharge tube. The supply/discharge tube is in selective flow communication with a product line. A compressed air connection communicates with the interior of the vessel between the inner surface of the vessel and the outer surface of the bladder. A vacuum draws the material into the supply/discharge tube through the perforations and into the bladder to expand the bladder when the tank is being filled. Compressed air presses against the bladder to squeeze the material back through the perforations of the supply/discharge tube and out of the product line when the material is being dispensed. The same accumulator tank can thereby be used for storing, transporting and dispensing flowable materials.

### BACKGROUND OF THE INVENTION

Flowable materials of low or high viscosity have various uses in different fields. For example, a material marketed by Henkel Corporation under the trademark TEROCORE® is used in the automotive industry to provide structural support for various components. The materials might be applied to a substrate while in a precured condition. and then cured upon the application of heat. Other types of flowable materials of either high or low viscosity have other uses in the automotive and other fields. Such flowable materials are generally stored in an accumulator tank. It is necessary to store the materials while at the manufacturing site and also to transport the materials to the end user where the materials would then be dispensed. It would be desirable if an accumulator tank could be provided which accomplishes all of the storage, transport and dispensing needs without requiring the materials to be moved from one storage tank to another tank.

### SUMMARY OF THE INVENTION

An object of this invention is to provide a pressurized accumulator tank which can store, transport and dispense flowable materials from low to high viscosity.

A further object of this invention is to provide such a pressurized accumulator tank which can easily be filled with the flowable materials and then transported to the end user so that the flowable materials would also be easily dispensed.

In accordance with this invention a pressurized tank for storing, transporting and dispensing flowable materials, which may be from low to high viscosity, comprises a pressure vessel having an outer rigid shell. A perforated anti-collapse supply/discharge tube is mounted in the shell. An expandable bladder is mounted in the shell around the supply/discharge tube and in the vicinity of the perforations. Flowable material is supplied to the. pressure vessel by feeding the material into the supply/discharge tube and then through the perforations and against the bladder to cause the bladder to expand toward the inner surface of the shell. The tank may be partially filled with the flowable material or may be filled to the point where the bladder is disposed directly against the inner surface of the shell. The supply/discharge tube is then closed and the accumulator tank may store the flowable material until it is desired to transport the material to the end user. The same tank would be used not only for storing and transporting the material but also for dispensing the material. The dispensing would be accomplished by feeding compressed air between the inner surface of the vessel shell and the outer surface of the bladder to squeeze or compress the bladder thereby forcing the flowable material back through the perforations and into the supply/discharge tube so that the material may then be dispensed from the discharge tube into a product line for ultimate use.

In accordance with a preferred practice of this invention the vessel is mounted on a pallet base to facilitate transporting of the vessel. Flowable material is preferably fed into and discharged from the supply/discharge tube through the same passage portion of the tube into or from the product line.

The supply/discharge tube is preferably coaxially mounted within the vessel to maximize the ability to store the flowable material within the expanded bladder. Preferably, the vessel shell is cylindrical over its main surface and includes an ellipsoidal upper head and an ellipsoidal lower head.

### THE DRAWINGS

FIG. 1 is a cross sectional view showing a pressurized accumulator tank in accordance with this invention in an intermediate stage of use;

FIG. 2 is a schematic view of the tank shown in FIG. 1 in the beginning of the filling operation;

FIG. 3 is a view similar to FIG. 2 during the filling operation;

FIG. 4 is a view similar to FIGS. 2-3 in the completely filled stage of operation;

FIG. 5 is a view similar to FIGS. 2-4 during the dispensing operation; and

FIG. 6 is a view similar to FIGS. 2-5 when the tank is ready to be refilled.

### DETAILED DESCRIPTION

In general, the invention is directed to a pressurized accumulator tank which includes a flexible bladder mounted over or around a perforated anti-collapse tube inside a pressure vessel which in turn is mounted on a pallet-type base. As a result, the tank may be used to store, transport and dispense both high and low viscosity materials which are referred to herein as flowable materials.

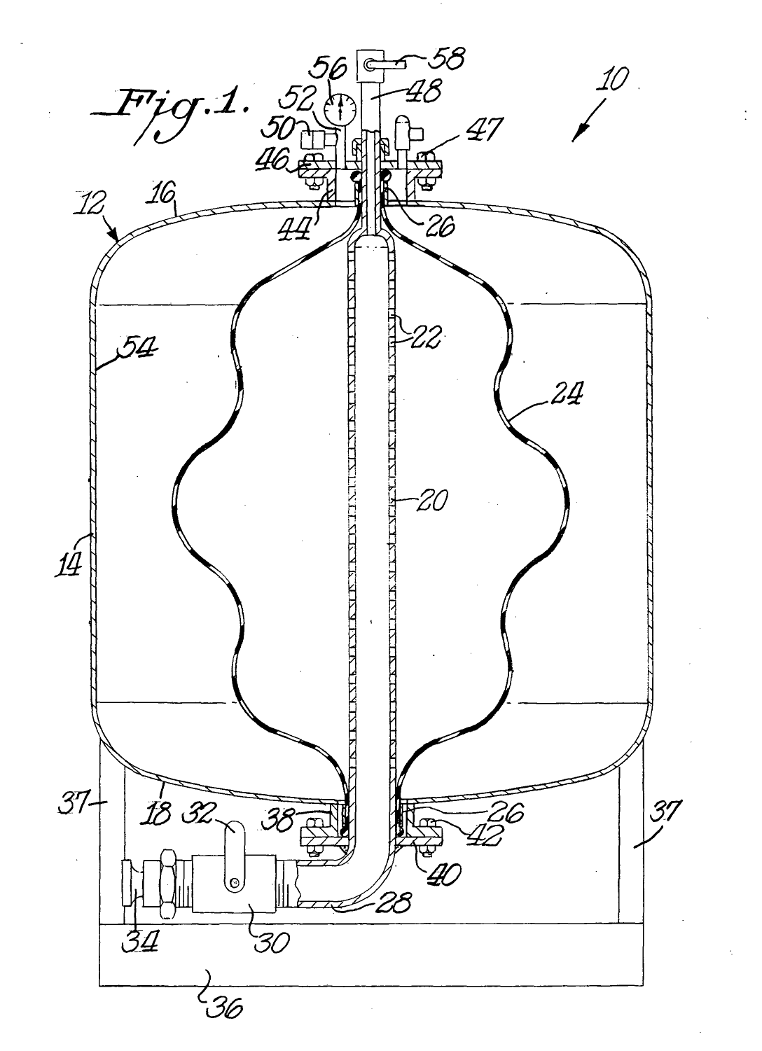

FIG. 1 illustrates a pressurized accumulator tank 10 in accordance with this invention. As shown therein the tank comprises a pressure vessel 12 which has an outer shell 14 made from a shape retaining and preferably rigid material. The shell 14 includes a central generally cylindrical portion over the main body of the shell with an upper ellipsoidal head 16 and a lower ellipsoidal head 18. Anti-collapse tube 20 is mounted preferably coaxially within vessel 12. Tube 20 includes a plurality of spaced perforations 22 throughout generally all of its length within the vessel 14. Since tube 20 is used both for supplying and discharging flowable materials into and from vessel 12 tube 20 may be considered as a supply/discharge tube.

An expandable flexible bladder 24 is mounted in vessel 12 surrounding supply/discharge tube 20 at least over its length which includes the perforations 22. Bladder 24 may be made of any suitable material such as rubber. Bladder 24 may be secured in any suitable manner around tube 20. In the preferred illustrated embodiment of this invention bladder 24 is detachably secured to supply/discharge tube 20 by a pair of clamps 26 at the upper and lower ends of tube 20. Clamps 26 may take any suitable form.

The lower end of tube 20 has an elbow extension 28 which communicates with the interior of tube 20. Flow extension 28 is threadably engaged with a collar 30 having a valve 32 which opens and closes flow communication to and from supply/discharge tube 20. A product line 34 is connected to elbow extension 28 by being threadably engaged to the opposite end of collar 30.

Vessel 12 is mounted on a pallet-type base 36 by being supported on a plurality of spaced legs 38. Preferably four equally spaced legs 37 are used so that product line 34 is readily accessible. Any suitable support arrangement could be used for mounting vessel 12 on the base 36. For example, tank 10 could rest on a seat-like structure having an opening for product, line 34.

The various components of tank 10 could be mounted together in any suitable manner which is not critical to the operation of this invention. As illustrated, a bracket 38 having a cylindrical wall and an outwardly extending peripheral projection is secured to lower ellipsoidal head 18. Bracket 38 shields clamp 26. A flange 40 is secured to bracket 38 by any suitable fasteners 42 such as nuts and bolts. Flange 40 is secured to tube 20 by welding or other means and extends around tube 20. This would detachably mount the tube 20 in the vessel 14. Similarly, the upper end of vessel 14 could include a bracket 44 mounted to flange 46, such as by fasteners 47, which secures the upper narrow extension 48 of tube 20 in place. Bracket 44 is a mirror image of bracket 38 and shields upper clamp 26. Flange 46 may also be used for providing a location for a compressed air connection 50 which communicates with line or passageway 52 leading to the space between the interior surface 54 of vessel 14 and the exterior surface of bladder 24. A pressure gauge 56 may also. be mounted to line 52.

As also illustrated in FIG. 1 an air vent valve 58 is provided at the end of narrow diameter extension 48 of tube 20.

Any suitable materials and sizes may be used for the various components of tank 10. For example, shell 14 may be made from 100 psi ASME rated shell made with rated components. The cylindrical portion of vessel 14 could be made from, 42 inch outside diameter standard type material with an overall height of about 66 inches. Vessel 14 could have about a 300 gallon capacity. Each ellipsoidal head 16,18 may be a 42 inch ellipsoid. The inside diameter of tube 20 extension 28 and product line 34 may be 3 inches. Flanges 40 and 46 may be of six inch diameter. Bladder 24 could be made of rubber.

FIGS. 2-6 illustrate the various stages of use of tank 10. FIG. 2 shows the stage of filling tank 1 0. As shown therein compressed air connection 50 is open to the atmosphere. Valve 58 is moved to the open position. A vacuum is then applied to the product air vent valve 58 at upper extension 48 to create a suction within supply/discharge tube 20. While in this condition bladder 24 is contracted to fit snugly against tube 20. This results from the bladder 24 being“sucked in” which is only necessary during the first fill but not after later use. Product line 34 is connected to a hose 60 communicating with a supply of flowable material. The flowable material product. is then pumped through product line 34, with valve 32 being in the open position to create communication between product line 34 and elbow extension 28 of tube 20. As shown the arrows in tube 20 indicate the direction of air flow which would result in the flowable material beginning to enter supply/discharge tube 20.

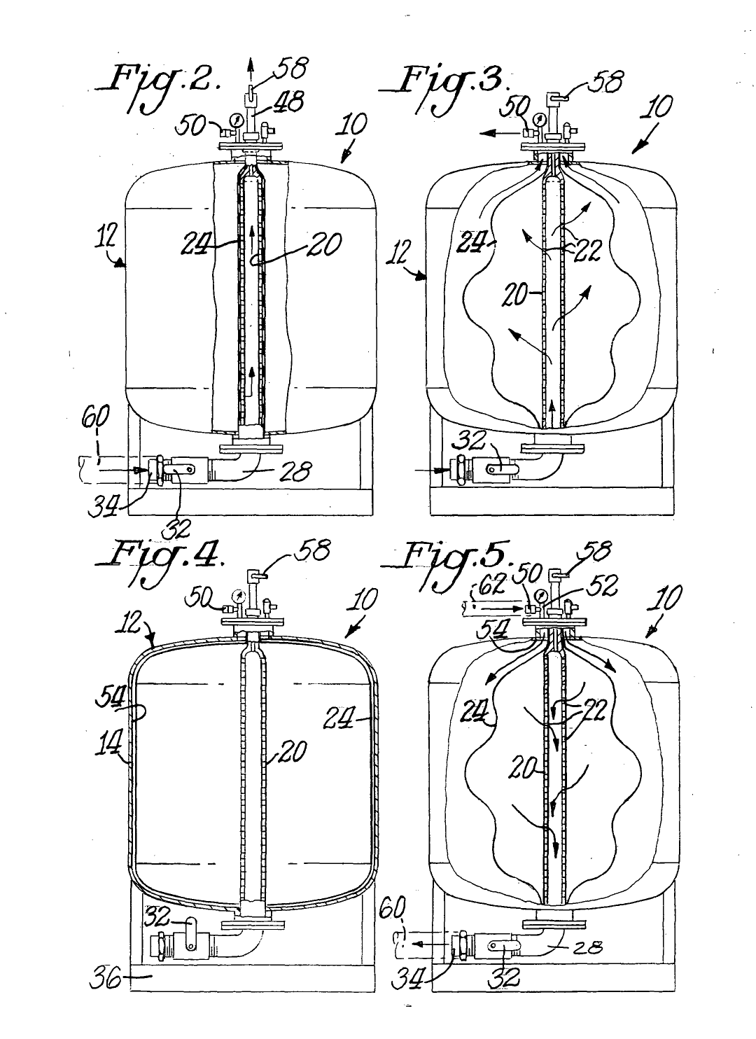

FIG. 3 shows a later stage of filling. As shown therein the flowable material flows through the perforations 22 of supply/discharge tube 20: against the inner surface of bladder 24 causing the flexible bladder 24 to expand outwardly as it is filled with the flowable material. In this stage, air between the outer surface of bladder 24 and the inner surface of shell 14 would be expelled from vessel 12 through connection 50 as also indicated by the arrows.

FIG. 4 illustrates the condition of tank 10 when vessel 12 is. completely filled. As shown therein bladder 24 has expanded to the same size and shape as the inner surface 54 of shell 14. The valve 32 would be moved to the off condition to prevent the flow of the material out of tube 20 and to prevent further material from flowing into tube 20. Connection 50 would be closed as would vent 58. When in this condition tank 10 stores the flowable material until it is ready to be shipped. Tank 10 also stores the fillable material during the transporting of the material to the end user or other desired location. Because vessel 12 is mounted on a pallet type base 36 conventional equipment, such as forklifts, could be used to assist in the transporting of tank 10.

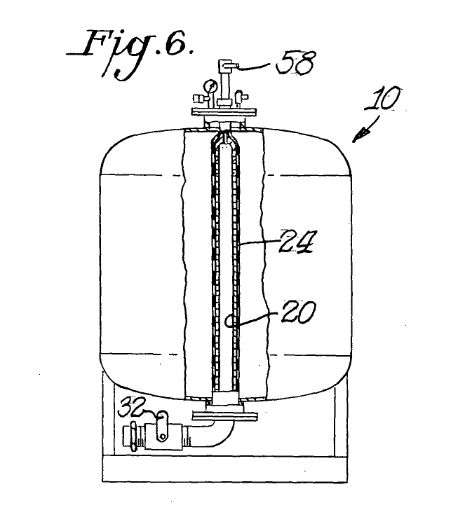

FIG. 5 illustrates the condition of tank 10 during unloading of the flowable material. As shown therein, product line 34 would be connected to an unloading hose 60 which leads to the site for collecting the flowable material. Valve 32 would be moved to the open position. An air line 62 would be connected to compressed air connection 50. The compressed air connection 50 would be in flow communication with pipe 52 and through line or passageway 52 would be in flow communication with the interior of vessel 12 communicating more specifically with the slight space that is maintained between the interior 54 of shell 14 and the outer surface of bladder 24 in the area where line 52 communicates with shell 14. The compressed air being fed into vessel 12 acts to squeeze against the outer surface of bladder 24 to force the flowable material back through the perforations 22 of supply/discharge tube 20 through elbow extension 28 and product line 34 and then into unloading hose 60. When all or the desired amount of flowable material has been discharged, valve 32 is moved to its closed position. The compressed air is no longer fed through connection 50 so that air line.62 can then be removed. The tank 10 is otherwise put in the condition shown in FIG. 2 ready to receive more material. Tank 10, however, may still contain some flowable material in which case bladder 24 would not be contracted snugly against supply/discharge tube 20 as is the condition shown in FIG. 2.

After the flowable material has been sufficiently discharged from supply/discharge 20, tank 10 is put in its condition ready to be refilled as shown in FIG. 6. The size of supply/discharge tube 20 is such that it has the capacity to hold two gallons of the flowable material when bladder 24 is contracted against supply/discharge tube 20. Thus, preferably this residual amount of flowable material remains in tank 10 with valve 58 and valve 32 in their closed position ready to receive an influx of additional flowable material. Preferably, the same type of flowable material would be used when tank 10 is refilled where there is still some residual material in supply discharge tube 20. If a different type of flowable material is to be used supply discharge tube 20 can be completely emptied and cleaned or replaced to permit fresh material to be fed into tank 10.

In the, preferred practice of this invention the inlet and outlet for the supply/discharge tube is structurally the same, namely, the elbow extension 28. If desired, separate inlets and outlets may be used, although such is not preferred.

Tank 10 may be used for storing, transporting and dispensing any suitable high or low viscosity materials. Examples of such flowable materials are found in U.S. Pat. Nos. 5,575,526, 5,755,486 and 5,884,960, all of the details of which are incorporated herein by reference thereto.

Tank 10 is constructed in such a manner that periodic maintenance can readily be accomplished such as by pulling or removing the bladder 24 for inspection or replacement purposes.

Tank 10 has numerous advantages. For example, tank 10 represents a completely closed system with no open totes, no dirt, no fumes and with the elimination of cleaning. No bag liners are required. No press is required to unload. Shop air could be used. Tank 10 could be emptied down to about a two gallon maximum with the remaining product protected in a totally closed chamber created by bladder 24 and supply/discharge tube 20. As a result, the flowable material should be 100% recyclable. In addition, tote filling lances and tote lids are eliminated. Although one version of tank 10 is shown with regard to relative sizes and shapes, tank 10 could be made in either larger or smaller sizes.

1. A pressurized accumulator tank for storing, transporting and dispensing flowable materials comprising a pressure vessel having an outer shell made of a shape retaining material, a perforated anti-collapse supply/discharge tube in said shell, said supply/discharge tube having an inlet opening for receiving the flowable materials, said supply/discharge tubing having an outlet opening for discharging the flowable materials, an expandable flexible bladder mounted around and enclosing said supply/discharge tube over a length which includes the perforations of said supply/discharge tube whereby the flowable materials in said supply/discharge tube may selectively flow from said supply/discharge tube into said bladder to expand said bladder and may flow from said bladder back into said supply/discharge tube when said bladder is contracted, said rigid shell having an inner surface, and a compressed air connection for connection to a source of compressed air mounted for feeding compressed air into said shell between said inner surface and said bladder to cause said bladder to contract and to thereby force the flowable materials in said bladder back into said supply/discharge tube and out of said outlet opening.

2. The tank of claim 1 wherein said inlet opening and said outlet opening are the same to comprise a combined inlet/outlet opening.

3. The tank of claim 1 wherein said supply/discharge tube includes an elbow extension extending laterally below the perforated portion of said supply discharge tube, a product line mounted to and in flow communication with said elbow extension, and a flow valve selectively opening flow communication between said product line and said elbow extension.

4. The tank of claim 3 wherein said vessel is mounted on a support base.

5. The tank of claim 4 wherein said support base is a pallet type base, said vessel being mounted on a plurality of legs which in turn are mounted on said support base, and said product line and said elbow extension being located between the bottom of said vessel and said support base.

6. The tank of claim 5 wherein said bladder is removably clamped to said supply/discharge tube.

7. The tank of claim 6 wherein said supply/discharge tube is coaxially mounted in said vessel.

8. The tank of claim 7 wherein said supply/discharge tube includes a narrower diameter upper extension connectable to a vacuum source, and a vent valve in said upper extension to selectively close flow communication with said upper extension and supply discharge tube.

9. The tank of claim 8 wherein a support flange is mounted at the upper end of said vessel, an air line mounted to said flange and communicating with said interior of said vessel, and said compressed air connection being mounted to and in flow communication with said air line.

10. The tank of claim 9 wherein said vessel includes a central cylindrical shell and top and bottom ellipsoidal heads mounted to said cylindrical portion of said shell.

11. The tank of claim 10 including a clamp mounting each end of said bladder to said supply/discharge tube at a location outside of said vessel to removably mount said bladder to said supply/discharge tube, a set of two brackets, each of said brackets having a cylindrical wall and an outwardly extending peripheral projection mounted to and externally of said vessel surrounding each of said clamps, one of said brackets being an upper bracket mounted to the upper surface of said vessel, the other of said brackets being a lower bracket mounted to the lower surface of said vessel, a tube flange mounted to and extending around said supply/discharge tube, and said tube flange being detachably secured to said outwardly extending peripheral projection of said lower bracket to detachably mount said supply/discharge tube to said vessel.

12. The tank of claim 11 wherein said support flange is detachably secured to said outwardly extending peripheral projection of said upper bracket.

13. The tank of claim 1 wherein said vessel is mounted on a support base.

14. The tank of claim 13 wherein said support base is a pallet type base, said vessel being mounted on a plurality of legs which in turn are mounted on said support base, and said product line and said elbow extension being located between the bottom of said vessel and said support base.

15. The tank of claim 1 including a clamp mounting each end of said bladder to said supply/discharge tube at a location outside of said vessel to removably mount said bladder to said supply/discharge tube, a set of two brackets, each of said brackets having a cylindrical wall and an outwardly extending peripheral projection mounted to and externally of said vessel surrounding each of said clamps, one of said brackets being an upper bracket mounted to the upper surface of said vessel, the other of said brackets being a lower bracket mounted to the lower surface of said vessel, a tube flange mounted to and extending around said supply/discharge tube, and said tube flange being detachably secured to said outwardly extending peripheral projection of said lower bracket to detachably mount said supply/discharge tube to said vessel.

16. The tank of claim 15 wherein a support flange is mounted at the upper end of said vessel, an air line mounted to said flange and communicating with said interior of said vessel, and said compressed air connection being mounted to and in flow communication with said air line.

17. The tank of claim 16 wherein said support flange is detachably secured to said outwardly extending peripheral projection of said upper bracket.

18. The tank of claim 1 wherein said supply/discharge tube is coaxially mounted in said vessel.

19. The tank of claim 18 wherein said supply/discharge tube includes a narrower diameter upper extension connectable to a vacuum source, and a vent valve in said upper extension to selectively close flow communication with said upper extension and supply discharge tube.

20. A method of filling and discharging a flowable material from an accumulator tank having a supply/discharge tube mounted in a rigid vessel of the accumulator tank, the tube being an anti-collapse perforated tube, an expandable flexible bladder mounted around the supply/discharge tube over the length of the tube having the perforations, an extension of the tube being located outside of the vessel and connected to a product line having a valve to control flow communication between the, product line and the tube extension, the vessel being mounted on a base, the filling steps comprising creating flow communication between the product line and the supply/discharge tube, disposing the product line in communication with a source of the flowable material, creating a vacuum in the supply/discharge tube to draw in flowable material through the product line and supply/discharge tube, feeding the incoming flowable material through the perforations of the supply/discharge tube to expand the bladder toward the inner surface of the vessel until a sufficient amount of flowable material has been fed into the vessel, the discharge steps comprising connecting a source of compressed air to an air connection which communicates with the interior of the vessel in a space between the interior of the vessel and the exterior of the bladder, opening communication between the product line and the supply discharge tube, mounting a discharge hose to the product line, feeding compressed air into the space between the interior of the vessel and the outer surface of the bladder to squeeze the bladder so that the bladder contracts to force the flowable material into the supply/discharge tube and out of the supply/discharge tube into the product line, closing communication between the product line and the supply discharge tube, and stopping the flow of compressed air into the vessel when a sufficient amount of flowable material has been discharged.
